(19) United States
(12) Patent Application Publication
(10) Pub. No.: US 2023/0407673 A1
(43) Pub. Date: Dec. 21, 2023

(54) Lock with Integrated Engagement Indicator

(71) Applicant: Yondr, Inc., San Francisco, CA (US)

(72) Inventor: Graham Dugoni, San Francisco, CA (US)

(21) Appl. No.: 17/844,560

(22) Filed: Jun. 20, 2022

(51) Int. Cl. E05B 39/00; E05B 65/52; E05B 15/04

(52) U.S. Cl. CPC E05B 39/00; E05B 65/5207; E05B 15/04; E05B 2015/0437

(57) ABSTRACT

A lock with an integrated visual indicator of its engagement is provided. Such lock comprises a resiliently extensible pin and an engagement means on a first plate and a means for securing the pin on a second plate. When an external force is applied to the engagement means, the pin and the means for securing the pin may engage one another and, as a result, secure the first and second plate to one another. The lock may be disposed on a container to prevent physical access to certain objects when engaged in this manner. The visual indicator may be provided to ensure compliance with any requirement that the lock be engaged to secure the first and second plate. A tampering indicator may also be disposed between the plates to visually confirm whether the lock has been tampered with when the plates are secured to one another.

### GOVERNMENT CONTRACT

Not applicable.

### CROSS-REFERENCE TO RELATED APPLICATIONS

Not applicable.

### STATEMENT RE. FEDERALLY SPONSORED RESEARCH/DEVELOPMENT

Not applicable.

### COPYRIGHT & TRADEMARK NOTICES

A portion of the disclosure of this patent document may contain material which is subject to copyright protection. This patent document may show and/or describe matter which is or may become trade dress of the owner. The copyright and trade dress owner has no objection to the facsimile reproduction by any one of the patent document or the patent disclosure, as it appears in the Patent and Trademark Office patent files or records, but otherwise reserves all copyrights and trade dress rights whatsoever.

### TECHNICAL FIELD

The disclosed subject matter relates generally to a lock, and more specifically, to a lock that provides a visual indication of the status of the lock.

### BACKGROUND

Cellular devices, such as phones, are incredibly useful in life for providing entertainment, information, and access to friends and family on demand. However, an average person now spends nearly five hours on their phone each day. As such, we often reach for our devices subconsciously, even when we are at events, such as dinner, school, the theater, or concert venues, when attention should be focused elsewhere. Thus, there is a need for a device that prevents distractions caused by cellular devices.

One method for preventing distractions caused by cellular devices is to require participants to turn their devices off for the duration of the event. However, this requires that the participants comply and can be challenging to enforce. While some phone applications, such as Digital Wellbeing produced by Android®, prevent access to specific apps and stop notifications, the proposed phone applications fail to prevent access to the device as a whole. Further, these applications are not suitable for preventing access at large events, as a participant can easily turn the application off, thus rendering it ineffective.

Other common proposals, such as lockers and check stations, designate places to leave devices at venues without requiring users to leave their devices behind completely. Still, lockers and check stations require the device to be left outside of each person's possession. While lockers may provide a greater sense of security than check stations typically manned and controlled by strangers, lockers nevertheless require the individual to leave their device in an area outside of their possession. Further, lockers require locks, such as those featured in U.S. Pat. No. 4,343,164 to Bako, U.S. Pat. No. 2,113,864 to Soref, and U.S. Pat. No. 1,597,560 to Solomon, to secure their contents. H however, these locks require the individual to remember their key or combination in order to access the locker, which can of course be burdensome to the individual. Indeed, failure to keep track of one's key or remember one's locker combination can create logistical problems, particularly among numbers of attendees at large events.

The inventor himself has proposed U.S. Pat. No. 9,819,788 in which male and female locking components securably mateable at the opening of a pouch, which allows an individual to maintain possession of their device while temporarily surrendering their use of the device. However, the inventor has found the fact that the static male component permanently extends from one face of the opening suboptimal. More particularly, the static, male component can scratch the user's device as it is placed in and removed from the pouch and, further, can cause damage or injury to the user's hand.

The inventor has also found that the static male component can be tampered with to prevent locking while allowing the lock to appear engaged. That is users who want to prevent their pouch from locking have been able to bend the static male locking component to prevent it from securely mating with the female locking component. Thus, this proposal has required that each pouch be physically inspected to confirm whether the lock is engaged effectively. Therefore, there remains a need to prevent lock tampering and further visual feedback on the actual state of the lock.

Thus, although various proposals have been made for different types of security locks, none of those in existence combine the characteristics of the present invention. As such, there is a need for a device that can selectively prevent access to the contents while maintaining possession, having a dynamic locking mechanism and a visual indication of the state of the lock.

### SUMMARY

The present disclosure is directed to a lock comprising a first plate and a second plate removably securable to each other by a pin resiliently extensible from the first plate and a means for securing the pin to the second plate. In an embodiment, the lock may be disposed on a container, such as a pouch, and be engageable to prevent physical access to certain objects, such as electronic devices, stored within the container while users retain physical possession of such devices.

For purposes of summarizing, certain aspects, advantages, and novel features have been described. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested.

In one embodiment, the lock may comprise a first plate and a second plate, each having an inside, an outside, and a side edge. An engagement means may be disposed on the outside of the first plate and comprise, in part, a pin resiliently extensible through and beyond the inside of such first plate.

The second plate may, in turn, comprise means for securing the pin to the second plate. In some embodiments, such means for securing the pin may be configured to engage the pin by force or by friction and, to that end, may comprise any of a variety of clamping mechanisms known to those of ordinary skill in the art. For instance, the means for securing the pin may comprise a conventional, cylindrical and magnetic ball-bearing locking system, or any other locking system capable of securely gripping the or otherwise securing the pin. As such, it is contemplated that the inside of the second plate may define a passage configured to receive the pin therein and permit the pin to engage with the means for securing the pin.

It is contemplated that the pin may resiliently extend from an interior of the engagement means through the first plate, and into, or, in some cases, through the passage to engage with the means for securing the pin to the second plate. As such, it will be apparent that the pin may be configured to securely mate with the second plate and prevent the first and second plates from being separated from one another in what will be referred to as a “locked state.” An “unlocked state” will therefore refer to any instance in which the pin is not secured to the second plate. It is contemplated that the pin may be wholly or at least partially retracted into the engagement means, or through the first plate, as the case may be, when in an unlocked state. In some embodiments, the engagement means may further comprise a button having a top and at least one sidewall extending therefrom, together defining a hollow interior. In some embodiments, an end of the pin may be securely disposed on an inside of the top of the button. In some embodiments, a spring, such as a compression spring known to those of ordinary skill in the art, may be further disposed within the hollow interior of the button and around the pin.

The button may take various forms without departing from the invention, which will be discussed in greater detail below. Briefly, it is contemplated that the button may comprise a rigid side wall; a flexible, collapsible sidewall; or even a plurality of sidewalls defining a segmented, stacked or nesting body. In any event, it is contemplated that the button may comprise a status indicator operative to display whether the lock is in a locked or unlocked state. In some embodiments, such status indicator may comprise a contrasting color or another characteristic visibly distinct from the top of the button so that when the engagement means is in an unlocked state, the contrasting characteristic of the at least one button sidewall is readily apparent to automatically, visually indicate such that the engagement means is in an unlocked state. Such visual indicator may comprise any of, without limitation, the display of color, image, word, or other distinct visual characteristics. In some embodiments, for instance, the visual indicator may be a visual change to the locks structure. Thus, the foregoing are offered by way of example only and not limitation.

When the engagement means is forcibly depressed or otherwise engaged in a locked state, the status indicator may be obscured or altered to visually indicate that the locked state. In some embodiments, for instance, the outside of the first plate may define a slot, collar, or other member defined by the outside of the first plate and configured to receive the at least one button sidewall such that, responsive to the application of an external force to the top of the button, the at least one sidewall may be received and obscured by the slot. Indeed, it will be recognized that the application of an external force to the top of the button will also cause the pin to traverse the width of the first plate. Should the application of external force be released, absent engagement with the means for securing the pin, the spring may be operative to resiliently return the button and pin to a visually indicated, unlocked state in which the pin is wholly or at least partially retracted into the engagement means, or through the first plate, as the case may be.

In some embodiments, the first and second plates may each comprise an alignment means configured to align the pin of the first plate with the passage defined by the inside of the second plate. For instance, a first alignment means disposed on the first plate may be a protuberance extending outward from the inside of the first plate. A second alignment means may be a corresponding depression defining an opening to the passage on the inside of the second plate that is complimentary to the protuberance on the first plate. Providing alignment means in this manner may aid the alignment of the first and second plates to ensure ready engagement of the pin with the means for securing disposed on the second plate regardless of any sizing or shape discrepancies between the first and second plates.

It is contemplated that when engaged in the locked state, the pin and the means for securing the pin to the second plate may not be disengaged until the occurrence of a predetermined condition. In other words, when engaged, the first and second plate are attached and can only be separated under specific circumstances. For example, the predetermined condition may be when the lock is provided with external stimuli. In one embodiment, the external stimuli may be a magnetic force. Alternatively, the external stimuli may be the presence of a key, code, or other external stimuli known in the art. It is contemplated that the external stimuli may cause the means for securing the pin to the second plate to disengage the pin, thus allowing the lock to return to the unlocked state. For example, when the external stimuli is the magnetic force, the magnetic force may act on the means for securing the pin to the second plate, causing the pin to disengage and return the unlocked state where it is substantially surrounded

In still another embodiment, the lock may be disengaged through an electrical means. In one such embodiment, the lock may be equipped with electronic receivers configured to receive a signal from a transmitter that instructs whether to engage or disengage the pin with the means for securing the pin to the second plate. Provided as non-limiting examples only, the electrical mean may be Near-Field Communications, Bluetooth, or changes in electrical current. A person of ordinary skill in the art will appreciate the aforementioned electrical means are provided for example only and all forms of electrical means are contemplated here.

In light of the foregoing contemplated conditions for unlocking, in some embodiments, the lock may further comprise a tampering indicator, such as any visual, audio, or other indicator known in the art, operative to indicate whether the lock has been forcibly, impermissibly disengaged.

The lock may be disposed on an opening of a container, such as a pouch, and it is contemplated that the lock may prevent at least one electronic device from being removed from or otherwise accessed in the container when in the locked state. In some embodiments, engaging the lock may prevent full access to the at least one electronic device. In another embodiment, engaging the lock may allow limited access to the at least one electronic device while preventing the at least one electronic device from being removed from the holding means. For example, in embodiments where the lock allows limited access, the electronic device may be connected to an externally powered charging device or allow the user to partially access the phone, such as allowing, for example, limited physical contact with the device to dismiss notifications, alter volume, and/or power on or off.

Several advantages of one or more aspects of the lock are that it:
a.) prevents injury when unlocked;
b.) is capable of being unlocked by a universal unlocking means;
c.) mechanistically, visually indicates whether the safety lock is effectively locked or unlocked; and
d.) is capable of integration into a variety of designs, including designs that allow a user to retain possession of their valuables while preventing access to them.

Thus, it is an object of the invention to provide a safety lock that reduces the risk of injury and damage to the user and object being locked.

It is another object of the invention to reduce tampering with the lock.

It is a further object of the invention to prevent access to or reduce physical manipulation of the locking components.

It is yet a further object of the invention to indicate when the lock is forcibly opened or otherwise tampered with in a manner that avoids damage the object being locked.

It is still another object of the invention to visually indicate engagement of the lock to readily confirm compliance when locking is required.

It is another object of the invention to allow users to retain possession of their valuables, such as cellular devices, while preventing physical access to the valuables.

It is still another object of the invention to provide a lock that can be opened without the need for a custom key or code while preventing others from accessing the contents.

One or more of the above-disclosed embodiments, in addition to certain alternatives, are provided in further detail below with reference to the attached figures. The disclosed subject matter is not, however, limited to any particular embodiment disclosed.

### BRIEF DESCRIPTION OF THE DRAWINGS

FIG. 1 shows a cross-sectional view of one embodiment of the lock in a disengaged state.

FIG. 2 shows a cross-sectional view of the lock of FIG. 1 in an engaged state.

FIG. 3 shows an exploded view of one embodiment of the lock in FIGS. 1-2 integrated onto a container.

FIG. 4 shows a cross-sectional view of another embodiment of the lock in a disengaged state.

FIG. 5 shows a cross-sectional view of the lock of FIG. 4 in an engaged state.

FIG. 6 shows an exploded view of one embodiment of the lock of FIGS. 4-5 integrated into a container.

FIG. 7 shows a cross-sectional view of one embodiment of the lock in a disengaged state.

FIG. 8 shows a cross-sectional view of the lock of FIG. 7 an engaged state.

FIG. 9 shows an exploded view of one embodiment of the lock of FIGS. 8-9 integrated into a container.

FIG. 10 shows a view of one embodiment of the lock comprising a tampering indicator means.

FIG. 11 shows a view of an embodiment of a lock integrated into a container.

The disclosed embodiments may be better understood by referring to the figures in the attached drawings, as provided below. The attached figures are provided as non-limiting examples for providing an enabling description of the method and system claimed. Attention is called to the fact, however, that the appended drawings illustrate only typical embodiments of this invention and are therefore not to be considered as limiting of its scope. One skilled in the art will understand that the invention may be practiced without some of the details included in order to provide a thorough enabling description of such embodiments. Well-known structures and functions have not been shown or described in detail to avoid unnecessarily obscuring the description of the embodiments.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus

The terms “couple,” “coupled,” “couples,” “coupling,” and the like should be broadly understood and refer to connecting two or more elements or signals, electrically, mechanically or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may be for any length of time, e.g., permanent or semi-permanent or only for an instant.

### DETAILED DESCRIPTION

Having summarized various aspects of the present disclosure, reference will now be made in detail to that which is illustrated in the drawings. While the disclosure will be described in connection with these drawings, there is no intent to limit it to the embodiment or embodiments disclosed herein. Rather, the intent is to cover all alternatives, modifications and equivalents included within the spirit and scope of the disclosure as defined by the appended claims.

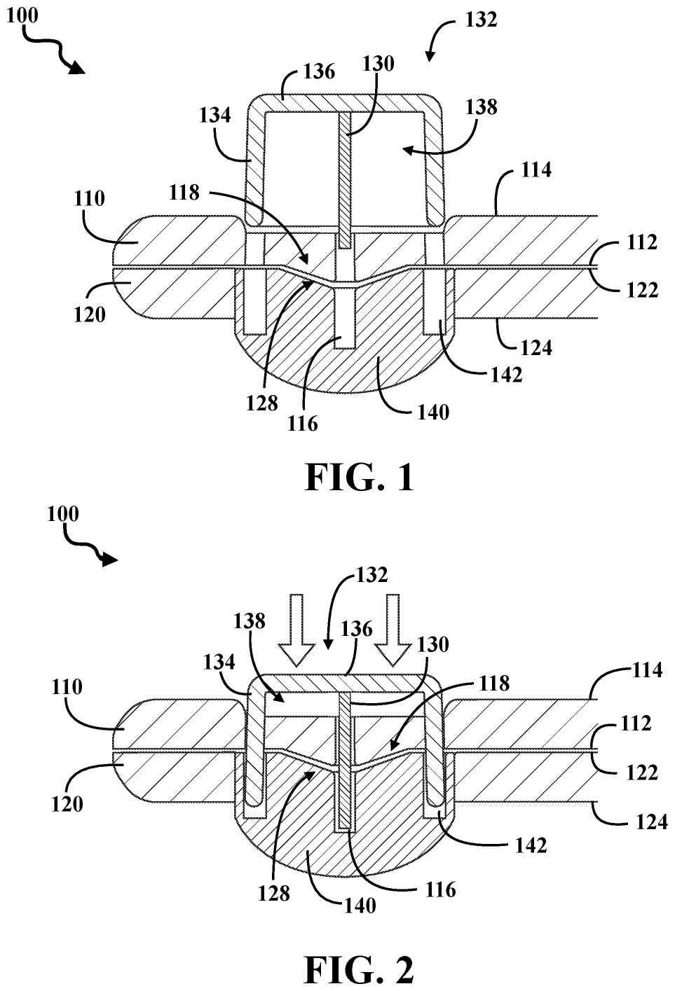

With reference to FIGS. 1-2 the lock 100 may comprise a first plate 110 having an inside 112 and an outside 114 and a second plate 120 having an inside 122 and an outside 124. The first plate 110 comprises a pin 130, engagement means as a button 132, while the second plate 120 defines a passage 116 configured to receive the pin and comprises a means for securing 140 the pin 130 to the second plate 120. The first plate 110 may comprise an edge defined by a space between the inside 112 and the outside 114. Further, the second plate 120 may comprise an edge defined by a space between the inside 122 and the outside 124.

The button 132 may be defined by a top 136 and at least one sidewall 134 extending from said top 136. The at least one sidewall 134 and top 136 may define a hollow interior 138 of the engagement means. The pin 130 may be contained within the hollow interior 138 of the button 132. More specifically, the pin 130 may be securely disposed on an inside of the top 136 of the button 132. It is contemplated that the pin 130 and the top 136 may be attached to form a continuous structure, however, they may be provided as distinct elements as needed or desired. It is contemplated that the pin 130 may traverse the width of the first plate 110 when an external force is applied to the top 136, as illustrated in FIG. 2.

As further illustrated in FIGS. 1-2, the second plate 120 may comprise a means for securing 140 the pin with the second plate. In some embodiments, such means for securing 140 the pin may be configured to engage the pin by force or by friction and, to that end, may comprise any of a variety of clamping mechanisms known to those of ordinary skill in the art. For instance, the means for securing the pin may comprise a conventional, cylindrical and magnetic ball-bearing locking system, or any other locking system capable of securely gripping the or otherwise securing the pin. As such, it is contemplated that the inside of the second plate may define a passage 116 configured to receive the pin therein and permit the pin to engage with the means for securing the pin. More particularly, the passage 116 may extend from the outside 124 to the inside 122 of the second plate 120. It is contemplated that the passage 116 may be sized to allow the pin 130 to traverse the passage 134 and engage with the means for securing 140 the pin to the second plate. For example, the passage 116 and the pin 130 may be sized for a clearance fit known in the art. The means for securing 140 the pin to the second plate may be aligned with the passage 116 on the first plate 110. This alignment may allow for the pin 130 to extend through the passage 116 and engage with the means for securing 140 the pin to the second plate.

In some embodiments, such as the exemplary embodiment shown, the first and second plates may define a slot 142 configured to receive the sidewall 134 therethrough so that the sidewall may be obscured within both the first and second plates when the pin 130 is engaged with the means for securing 140 the pin 130. However, the foregoing is offered by way of example only and not limitation. In some embodiments, for instance, the outside 114 of the first plate 110 alone may define a slot or collar or other means for obscuring the sidewall 134 when the pin 130 is secured to the second plate 120.

The inside 112 of the first plate 110 may comprise a first alignment means 118 and the inside 122 of the second plate 120 may comprise a second alignment means 128. The first alignment means 118 and the second alignment means 128 may be operative to align the first plate 110 with the second plate 120 and, more particularly, the passage 116 with the pin 130. In one exemplary embodiment, the first alignment means 118 may, for example, be a protuberance extending from the inside 112 of the first plate 110. In such an exemplary embodiment, the second alignment means 128 may, for example, be a complementary depression located on the inside 122 of the second plate 120 configured to receive, such as by nesting or mating with, the protuberance. The aforementioned alignment means are provided, for example only, and a person of ordinary skill in the art will appreciate that all alignment means, such as alternatively shaped protuberances and depressions, hook and fasteners, and even joints, may be used in the present invention.

FIG. 1 shows pin 130 disengaged from the means for securing 140 the pin to the second plate. Put another way, FIG. 1 shows the lock 100 when the first plate 110 is not securely mated to the second plate 120, referred to as an “unlocked state” In the unlocked state, the button 132 protrudes from the outside 114 of the first plate 110. It is contemplated that the pin 130 and button 132 may extend through the outside 114 of the first plate 110 when in the unlocked state. In other words, the pin 110 may be contained within the interior 138 of the button 132 and at least partially retracted when the lock 100 is in an unlocked state.

FIG. 2 illustrates the lock 100 in a “locked state” where the first plate 110 and the second plate 120 are secured. It is contemplated that the lock 100 may transition from the unlocked to the locked state, and thus the pin 130 moves from being disengaged to engaged with the means for securing 140 the pin to the second plate through the application of an external force on the top 136 of the button 132, demonstrated by arrows in the figure. The button 132 may act on the pin 130, forcing the pin 130 downwards through the passage 116 until the pin 130 engages the means for securing 140 the pin to the second plate 120.

It is contemplated that the lock 100 may comprise a status indicator operative to indicate whether the lock is in the locked state, illustrated in FIG. 1, or the unlocked state, shown in FIG. 2. In one embodiment, the status indicator may be a visual indicator. For example, the visual indicator may be a visual change to the first plate 110 as the button 132 has a reduced height when in the locked state. As shown in FIG. 2, the top 136 may remain visible from the outside 114 of the first plate 110 when the pin 130 is engaged, while the at least one sidewall 134 may be contained within the first plate 110 and, as in the exemplary embodiment, within the second plate 120 as well. Thus, obscuring simply obscuring the at least one sidewall 134 may readily visually demonstrate that the lock 100 is in the locked state. As another example, the at least one sidewall 134 of the button 132 may comprise a contrasting color or visible marking that is readily discernible when the button is disengaged. It is contemplated that in the locked state, the color or marking may be at least partially obscured from view, thus indicating the lock is in the locked state.

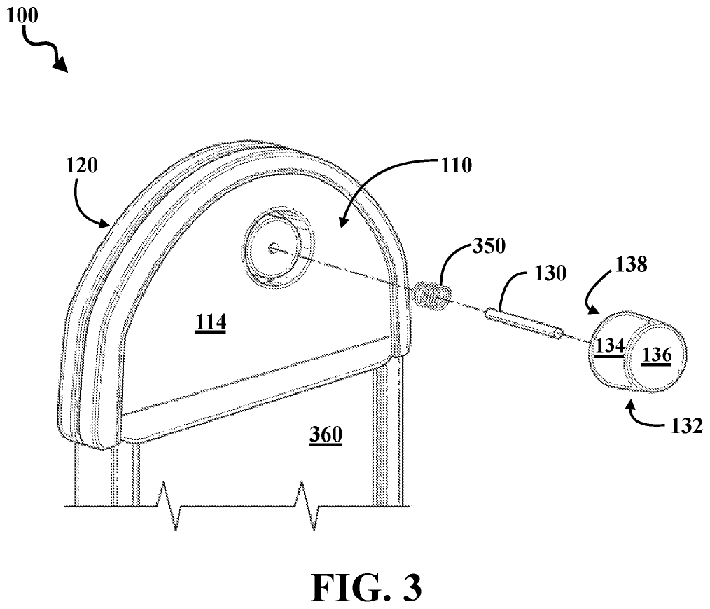

FIG. 3 provides an exploded view of the exemplary lock 100 of FIGS. 1-2 integrated into and defining the opening of a pouch 360.

In the example shown, the button 132 may be defined by at least one sidewall 134 extending from a top 136 to define an interior 138 of the engagement means. The pin 130 may be contained within the interior 338. In addition, a spring 350 may be provided and disposed to surround a portion of the pin 330 contained within the interior 138 of the button 132. The spring 350 may resiliently operate on the pin 130, rendering the pin 130 resiliently extensible through the first plate 110. It is contemplated that the pin 130 and the button 132 may be distinct, separable elements as shown in FIG. 3. However, it is also contemplated that the pin 130 and the button may form a single structure without departing from the invention.

In an embodiment, the spring 350 may be operative to compress when an external force is applied to the button 332. Thus, when the pin 330 is engaged with a means for securing 340 the pin to the second plate, the spring 350 may be compressed. Disengaging the pin 330 with the means for securing the pin to the second plate 120 may cause the spring 350 to elastically extend through the first plate 110. It will be recognized to those of ordinary skill in the art that the spring 350 elastically extending in this manner may return the button 132 and pin 130to the unlocked state.

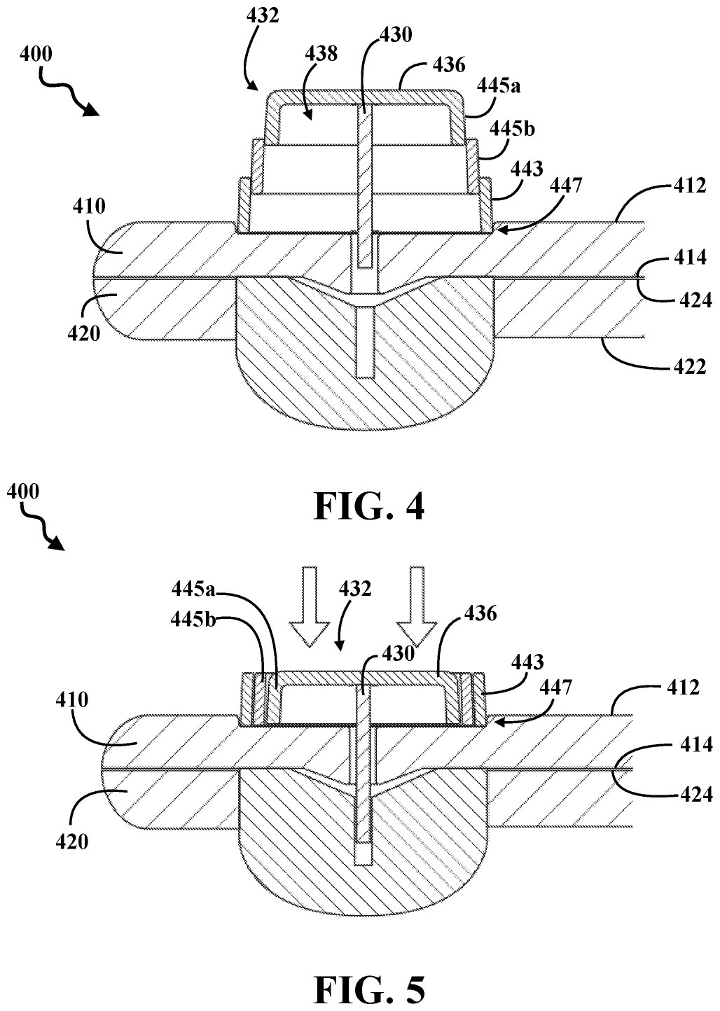

Another embodiment of a lock 400 is illustrated in FIGS. 4-5. For the sake of brevity discussion of the following embodiments will be particularly directed to the various embodiments of the means for engagement. It is to be understood that all embodiments of the lock comprise a first plate, second plate, pin, and means for securing the pin to the second plate as described above. Thus it may be seen, as in FIGS. 1-3, above, in the exemplary embodiment of the lock in FIGS. 4-5, the lock 400 may comprise a first plate 410 having an inside 412, an outside 414, and a second plate 420 having an inside 422, an outside 424, where the second plate defines a passage 416, a pin 430, and means for securing 440 the pin (examples of which are described above) to the second plate 420, alignment means, and a visual indicator.

Here, the lock 400 may comprise an engagement means as a stacked body 432. The second plate 420 may comprise the means for securing 440 to the second plate and the passage 416 defined by the means for securing 440 the pin to the second plate. The passage 416 may traverse at least a portion of any distance between the inside 422 and the outside 424 of the second plate 420.

The stacked body 432 may comprise a base member 443 and at least one interconnected section 445. As shown in FIG. 4, the stacked body 432 may comprise two interconnected sections 445a and 445b. However, it is contemplated that the at least one interconnected section 445 may be any number of sections, for example, and without limitation, one, three, four, five, or even more interconnected sections. A person of ordinary skill in the art will appreciate that these numbers are provided for example and without limitation and that other numbers of interconnected sections are available in the present invention.

In some embodiments, the at least one interconnected section 445 may be continuous with the base member 443 to form the stacked body 432. However, any of the at least one interconnected section 445 may be distinct from the base member 443, where each of the distinct elements are configured to move concentrically along a length of an adjacent section.

The stacked body 432 illustrated in FIG. 4 is in an expanded state. The expanded state may coincide with the lock 400 in an unlocked state. The stacked body 432 is in an expanded state when the at least one interconnected section 445 extends from the base member 443. In such an embodiment, the pin 430 may be contained within an interior 438 of the stacked body 432. The pin 430 may be securely disposed on the interior 438 of a top 436 of the stacked body 432. The top 436 may be a surface that extends over the most distal of the at least one interconnected section 445 of stacked body 432. With particular reference to FIG. 4, the outermost of the at least one interconnected section 445, may be interconnected section 445a. It is contemplated that the pin 430 and the top 436 may be attached to form a continuous structure, however, they may be distinct elements.

FIG. 5 illustrates the stacked body 432 in a collapsed state. The collapsed state may coincide with the lock 400 in a locked state. The stacked body 432 may be in the collapsed state when the at least one interconnected section 445 is at least partially nested in the base member 443. It is contemplated the stacked body 432 may move from the unlocked state of FIG. 4 to the locked state of FIG. 5 through the application of an external force on the at least one interconnected section 445. The external force may cause the at least one interconnected section 445 to move concentrically with respect to the base member 443. In instances where there is a plurality of the at least one interconnected section 445, shown in FIG. 5, interconnected section 445a may move concentrically with another interconnected section 445b and the base member 443. The application of the external force may cause the at least one interconnected section 445 to at least partially nest with base member 443. The nesting may be accomplished by interconnected section 445a nesting concentrically with interconnected section 445b, which then nests concentrically with the base member 443. It is contemplated that the stacked body 432 may be configured with any number of interconnected sections that are capable of nesting concentrically with an adjacent interconnected section.

The at least one interconnected section 445 may have the same or different height as any of the at least one interconnected section 445. As an example, the height of the at least one interconnected section 445b connected to the base member 443 may have the greatest height. As a further example with reference to FIG. 4, the height of interconnected section 445b may have the same height as interconnected section 445a. It is further contemplated that the interconnected section 445b connected to the base member 443 may have a height less than the base member 443.

In some embodiments, the at least one interconnected section may have a height greater than the base member. Thus, the at least one interconnected section may extend past the base member. It is contemplated that the stacked body, in such an embodiment, the collapsed state would nevertheless have a height less than the height of the stacked body in the expanded state. Returning to FIGS. 4-5, it is contemplated that the change in the height of the stacked body 432 may be operative to provide a status indication on whether the lock is in the locked or unlocked state. Of course, as referenced above, the visual indicator may comprise a discernible contrasting color, design, word, or the like, disposed on any outer surface of the interconnected sections as may be visible in the unlocked state.

In a further embodiment, the first plate may comprise a recess 447 defined by the base member 442. The recess 447 may allow the base member 443 to extend partially through the edge of the first plate 410. Thus, in embodiments where the at least one interconnected section has a height greater than the base member, the at least one interconnected section 445 may nest within the base member 443 and the recess 447.

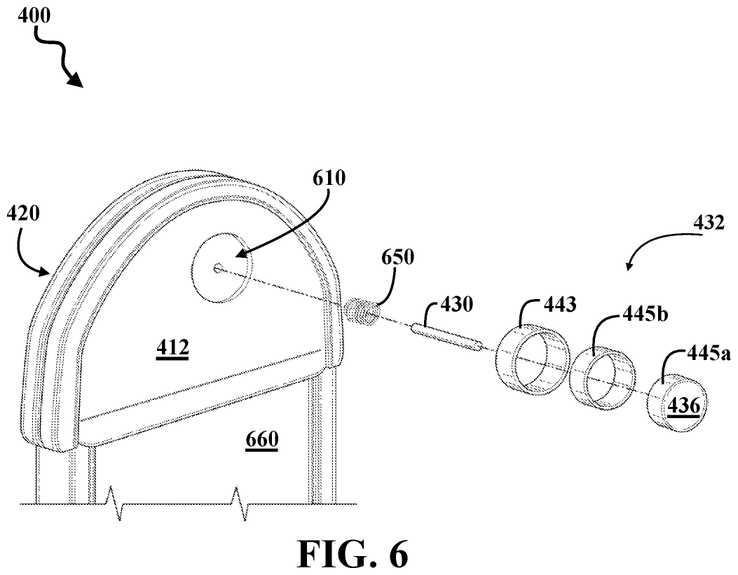

FIG. 6 illustrates an exploded view of an embodiment of the lock 400 having a stacked body 432 engagement means comprising an internal spring 650 integrated into a pouch 660.

The exemplary exploded view shows the exemplary stacked body 432 base member 443, at least one interconnected section 435, and top 436. The pin 630 may be securely disposed on an inside of the top 436 within an interior defined by the stacked body 432. While the pin 430 is shown as a separate and distinct element from the top 436, it is contemplated the pin and the top may be a continuous structure without departing from the invention.

As above, the pin 430 may be resiliently extensible through the first plate 410 and the spring 650 may be operative to compress when an external force is applied to the top 436. Thus, the spring 650 may compress when the at least one interconnected section 645 moves concentrically to at least partially nest with the base member 643 and the pin 630 may traverse the first plate 610. It is contemplated that when the pin 630 and the means for securing 640 the pin to the second plate are secured, the spring 650 may remain compressed. Disengaging the pin 430 with the means for securing the pin to the second plate may allow the spring 650 to elastically extend beyond the outside first plate 412. The elastic extension of the spring 650 in this manner may act on the top 436 applying an internal upwards force. The internal upwards force may allow the at least one interconnected section 445a,b to return to an expanded state.

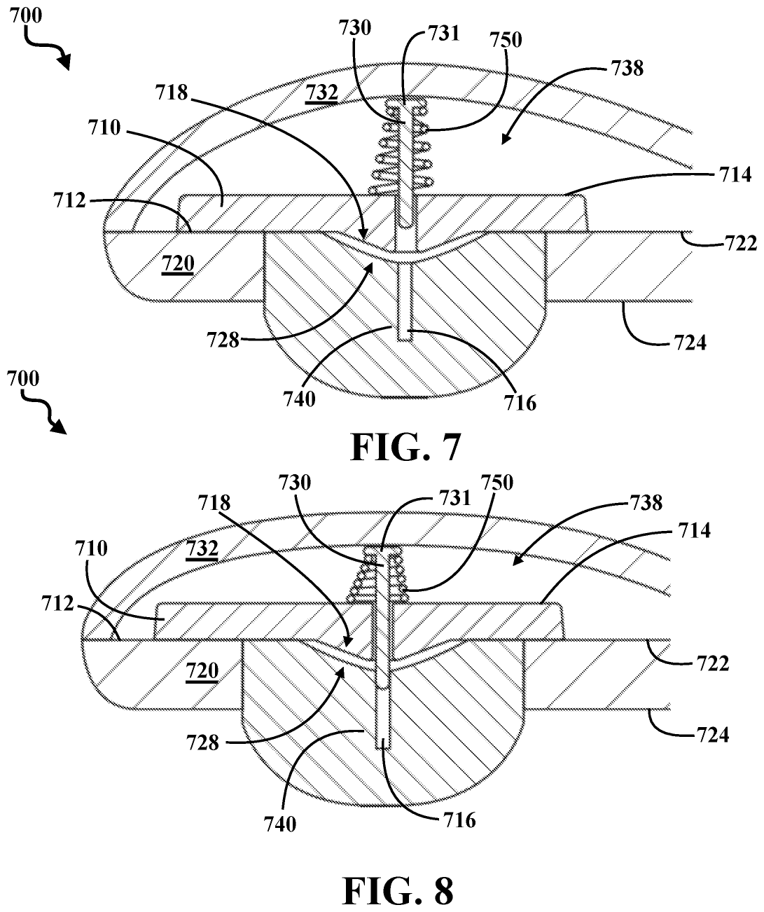

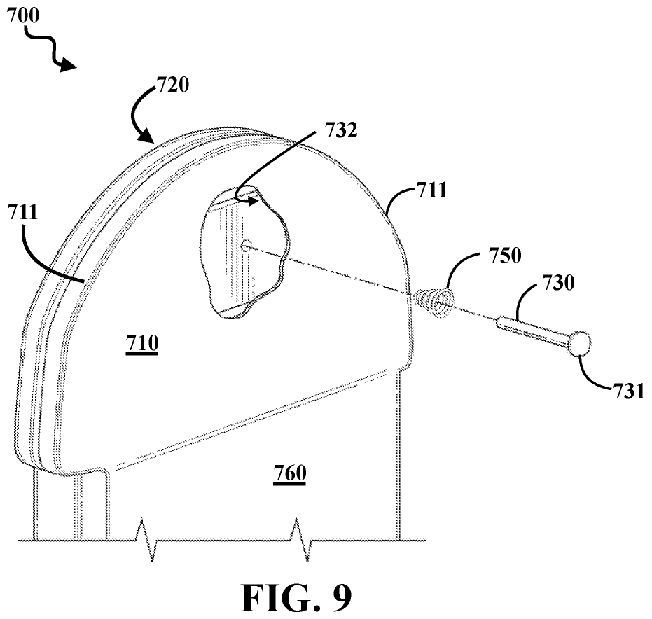

As above, FIGS. 7-9 illustrate an embodiment of the lock 700 comprising a first plate 710 having an inside 712, an outside 714, and the outside 714, and a second plate 720 having an inside 722, an outside 724, a pin 730, wherein the second plate 720 defines a passage for receiving the pin, and means for securing the pin 740 to the second plate 720. In this embodiment, however, the means for engagement comprises, simply a head 731 disposed on the pin 730 and a spring 750 and, optionally, a covering 732. As shown in FIGS. 7-8, the spring 750 may surround a portion of the pin 730 located between the first plate 710 and the covering 732.

The covering 732 may be connected to an edge of the first plate 710 and extend over at least a portion of the first plate 710 and the pin 730. It is contemplated that the covering 732 may be sized such that the covering 732 extends over the first plate 710 when the pin 730 is disposed on the first plate 710. The covering 732 may be made of a flexible material, such as plastic, rubber, natural and/or synthetic fabric, and combinations of the same. The covering 732 may be operative to protect the lock 700 from being tampered with by preventing direct access to the pin 730.

As shown in FIGS. 7-9, the pin 730 may comprise a head 731 located on an end of the pin 730 distal to the first plate 710. It is contemplated that the head 731 may act as a stopper and prevent the pin 730 from fully traversing the length of the first plate 710. The spring 750 may be further operative to prevent the pin 730 from fully passing through the first plate 710. The spring 750 may surround a portion of the pin 730 extending through the outside of the first plate 710.

As above, the inside 712 of the first plate 710 may comprise a first alignment means 718 and the inside 722 of the second plate 720 may comprise a second alignment means 728. The first alignment means 718 and the second alignment means 728 may be operative to align the first plate 710 with the second plate 720. More particularly, the first alignment means 718 and the second alignment means 728 may align the pin 730 with the passage 716. As shown in FIGS. 7-8, the first alignment means 718 may be a protuberance extending from the inside 712 of the first plate 710 and the second alignment means 728 may be a depression on the inside 722 of the second plate 720.

FIG. 7 illustrates the lock 700 in an unlocked state, wherein the pin 730 and the means for securing 740 the pin to the second plate are disengaged. The spring 750 may be in an expanded state, and thus uncompressed, when in the unlocked state. It is contemplated that the pin 730 may act on the covering 732, creating an interior 738 that houses at least a portion of the pin 730 and the spring 750. More specifically, the covering 732 may contact the head 731 of the pin 730.

FIG. 8 illustrates the lock 700 in a locked state, wherein the pin 730 and the means for securing 740 the pin to the second plate are engaged, thus securing the first plate 710 to the second plate 720. The lock 700 may move from the unlocked state in FIG. 7 to the locked state of FIG. 8 through the application of an external force. The external force may be applied to the head 731 until the pin 730 resiliently extends from the first plate 710. With particular reference to FIG. 8, as the portion of the pin 730 within the interior 738 is reduced, the spring 750 may surround a smaller portion the pin 730. In some embodiments, not shown, when in the locked state, the covering may rest directly on top of the outside of the first plate, thus the absence of an interior 738 may occur during the locked state.

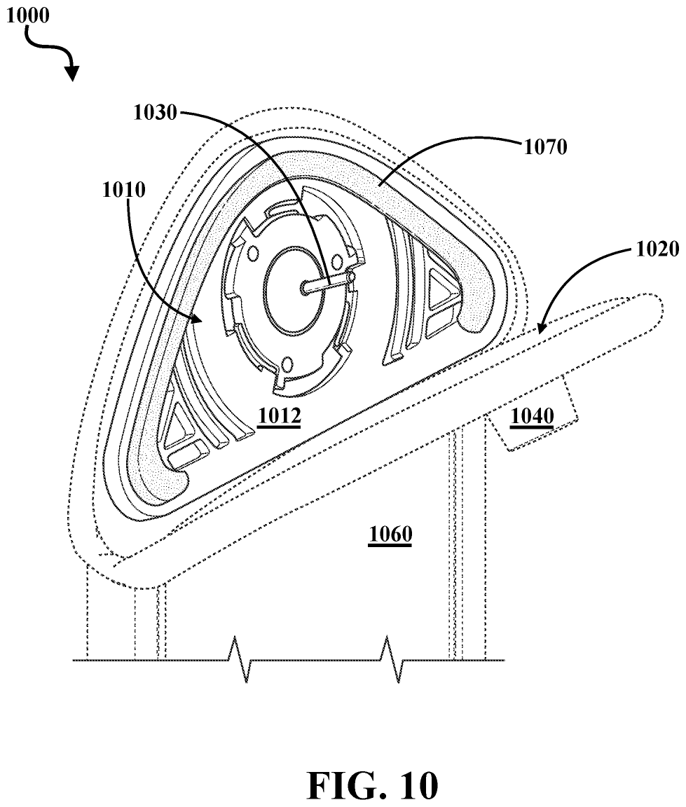

FIG. 10 illustrates one embodiment of a lock 1000 integrated into an opening to a pouch 1060 as an exemplary container and further comprising a tampering indicator 1070 disposed on an inside 1012 of a first plate 1010. Of course, the lock may comprise the first plate 1010 and a second plate 1020, an engagement means, a pin 1030 resiliently extensible from the first plate 1010, and a means for securing 1040 the pin to the second plate. The tampering indicator 1070 may be disposed on an inside of either or both of the first plate 1010 and the second plate 1020 (here, the first plate 1010), and as such will be positioned between the plates 1010, 1020 when secured. The tampering indicator 1070 may be any of those know to those of ordinary skill of the art to be operative to indicate whether the lock 1000 has been impermissibly tampered with. It is contemplated that the tampering indicator 1070 may be a visual, audio, or other indicator.

Tampering is contemplated to include anyone trying to forcibly pry the first plate 1010 and the second plate 1020 apart, inserting a tool between the first plate 1010 and the second plate 1020, or applying pressure to break the first plate 1010 or second plate 1020. A person of ordinary skill in the art will appreciated that the discussed forms of tampering are for example only and that all forms of tampering are contemplated here.

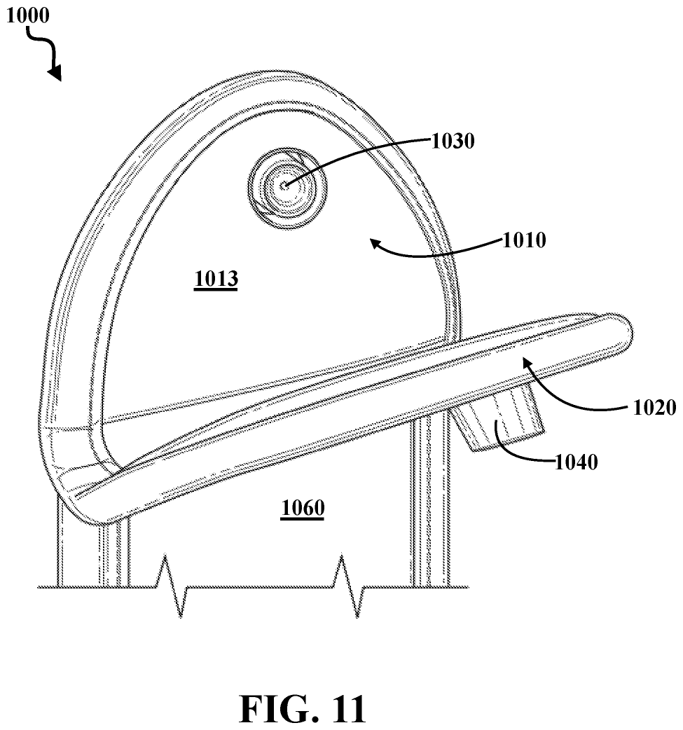

As shown in FIG. 10, the tampering indicator 1070 may be an ink pouch operative to provide a visual indication when the lock 1000 has been tampered with by staining the skin or clothing of the tampering party, or even by staining or coloring the material comprising the lock or container. As shown in FIG. 11, the first and second plates 1010, 1020 may be at least partially covered or enclosed to obscure the plates 1010, 1020 from view. The tampering indicator 1070 may be disposed between, for instance, the inside of the first plate 1010 and the covering 1013. The tampering indicator 1070 may be operative display on the covering 1013 when the lock 1010 has been tampered with. For example, the tampering indicator 1070 may be operative to stain the covering 1013 with ink when tampered with. Further, the tampering indicator 1070 may be operative to stain the covering 1013 and the second covering 1023 with ink when tampered with.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

### CONCLUSIONS, RAMIFICATIONS, AND SCOPE

While certain embodiments of the invention have been illustrated and described, various modifications are contemplated and can be made without departing from the spirit and scope of the invention. For example, the lock may comprise multiple pins and means for securing the pins. Accordingly, it is intended that the invention not be limited, except as by the appended claim(s).

The teachings disclosed herein may be applied to other systems, and may not necessarily be limited to any described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions and concepts of the various references described above to provide yet further embodiments of the invention.

Particular terminology used when describing certain features or aspects of the invention should not be taken to imply that the terminology is being refined herein to be restricted to any specific characteristics, features, or aspects of the indicator lock with which that terminology is associated. In general, the terms used in the following claims should not be constructed to limit the indicator lock to the specific embodiments disclosed in the specification unless the above description section explicitly define such terms. Accordingly, the actual scope encompasses not only the disclosed embodiments, but also all equivalent ways of practicing or implementing the disclosed system, method and apparatus. The above description of embodiments of the indicator lock is not intended to be exhaustive or limited to the precise form disclosed above or to a particular field of usage.

While specific embodiments of, and examples for, the method, system, and apparatus are described above for illustrative purposes, various equivalent modifications are possible for which those skilled in the relevant art will recognize.

While certain aspects of the method and system disclosed are presented below in particular claim forms, various aspects of the method, system, and apparatus are contemplated in any number of claim forms. Thus, the inventor reserves the right to add additional claims after filing the application to pursue such additional claim forms for other aspects of the indicator lock.

What is claimed is:

1. A lock, comprising:
a first and a second plate each having an inside and an outside, the second plate defining a passage configured to receive the pin;
an engagement means disposed on the first plate and protruding from the outside of the first plate;
a pin resiliently extensible from an interior of the engagement means though to the outside of the first plate; and
means for securing the pin to the second plate disposed on the second plate accessible via the passage.

2. The lock of claim 1, wherein the engagement means comprises a stacked body operative to collapse when an external force is applied to a top surface of the stacked body, the stacked body comprising a base member and at least one interconnected section, each of the at least one interconnected sections configured to move concentrically with respect to each other and the base member upon application of an external force to the top surface.

3. The lock of claim 2, wherein application of external force causes at least one interconnected section of the stacked body to at least partially nest in the base member, engaging the pin with the means for securing the pin to the second plate, and preventing the stacked body from returning to an expanded state until the pin is disengaged from the means for securing the pin to the second plate.

4. The lock of claim 1, wherein the engagement means comprises a button having a top and at least one sidewall extending from the top to define the interior of the engagement means and a spring, the pin secured to an inside of the top within the interior and surrounded by the spring.

5. The lock of claim 1, wherein the engagement means comprises a spring surrounding the pin and a covering extending over a portion of the outside of the first plate and the pin.

6. The lock of claim 1, wherein the first and second plates are disposed on opposing sides of an opening to a pouch, wherein the engagement of the pin and the means for securing the pin to the second plate prevents access to the opening of the pouch.

7. The lock of claim 1, further comprising a tampering indicator configured to visually indicate whether the pin has been forcibly disengaged from the means for securing the pin to the second plate.

8. The lock of claim 1, further comprising a status indicator operative to visually demonstrate whether the lock is engaged with the means for securing the pin to the second plate.

9. The lock of claim 8, wherein engagement of the pin with the means for securing the pin to the second plate defines a locked state, and wherein retraction of the pin into the interior of the engagement means defines an unlocked state.

11. A lock for a container comprising:
a first and second plate each having an inside and an outside;
an engagement means disposed on the first plate and protruding from the outside of the first plate;
a pin resiliently extensible from an interior of the engagement means;
means for securing the pin to the second plate disposed on the second plate, wherein the inside of the second plate defines a passage configured to receive the pin; and
a status indicator operative to visually indicate whether the lock is in a locked or unlocked state.

12. The lock of claim 11, wherein the status indicator is configured to indicate an unlocked state via an exterior surface of the engagement means.

13. The lock of claim 11, wherein the status indicator is a color visually distinct from the first plate or container disposed on an exterior surface of the engagement means.

14. The lock of claim 11, wherein the status indicator is at least partially obscured when the pin is engaged with the means for securing the pin.

15. The lock of claim 11, wherein the status indicator comprises a visually discernible protrusion from the outside of the first plate.

16. The lock of claim 11, further comprising a tampering indicator disposed on the inside of at least one of the first and second plates, the tampering indicator operative to provide a visual indication that tampering with the lock has occurred when the pin and the means for securing pin to the second plate are engaged.

17. The lock of claim 11, wherein the engagement means comprises a stacked body operative to collapse when an external force is applied to a top surface of the stacked body, the stacked body comprising a base member and at least one interconnected section each of the at least one interconnected section configured to move concentrically with respect to each other and the base member upon application of an external force to the top.

18. The lock of claim 17, wherein the external force causes at least one interconnected section of the stacked body to at least partially nest in the base member, engaging the pin with the means for securing the pin to the second plate, and preventing the stacked body from returning to an expanded state until the pin is disengaged from the means for securing the pin to the second plate.

19. The lock of claim 11, wherein the engagement means comprises a button having a top and at least one sidewall defining a hollow interior and a spring, the pin secured to an inside of the top within the hollow interior and surrounded by the spring.

20. The lock of claim 11, wherein the engagement means comprises a spring and a covering extending over a portion of the outside of the first plate and the pin.
